(19) United States
(12) Patent Application Publication
(10) Pub. No.: US 2026/0155362 A1
(43) Pub. Date: Jun. 4, 2026

(54) ANODE ACTIVE MATERIAL, ANODE FOR SECONDARY BATTERY COMPRISING THE SAME, AND SECONDARY BATTERY COMPRISING THE SAME

(71) Applicants: Hyundai Motor Company, Seoul (KR); Kia Corporation, Seoul (KR)

(72) Inventors: DONGJUN KIM, Hwaseong-Si (KR); WonKeun KIM, Hwaseong-Si (KR); YOUNGWOO LEE, Hwaseong-Si (KR); Sooyoun PARK, Hwaseong-Si (KR); Heesoo JEONG, Hwaseong-Si (KR); Sucheol KIM, Hwaseong-Si (KR); SHINKOOK KONG, Hwaseong-Si (KR); Jeongwoo LEE, Hwaseong-Si (KR)

(21) Appl. No.: 19/220,298

(22) Filed: May 28, 2025

(30) Foreign Application Priority Data
Nov. 29, 2024 (KR) 10-2024-0175258

(51) Int. Cl. H01M 4/38; H01M 4/02; H01M 4/36; H01M 4/583; H01M 10/056

(52) U.S. Cl. CPC H01M 4/386; H01M 4/364; H01M 4/583; H01M 10/056; H01M 2004/027

(57) ABSTRACT

An anode active material according to an example of the present disclosure comprises: a first active material comprising a silicon-based material; and a second active material comprising a carbon-based material, in which the second active material comprises at least one of the first carbon-based material and the second carbon-based material, and a full length expansion rate or a full width expansion rate of an anode comprising the anode active material satisfies the following Expression 3: [Expression 3] a1=k1*x/y, a2=k2*x/y, wherein a1 denotes the full length expansion rate, a2 denotes the full width expansion rate, k1 and k2 denote real numbers, and x denotes a weight of the first carbon-based material, and y denotes a weight of the second carbon-based material.

### CROSS-REFERENCE TO RELATED APPLICATION

This application claims priority to Korean Patent Application No. 10-2024-0175258, filed on Nov. 29, 2024, in the Korean Intellectual Property Office, the entire disclosure of which is incorporated herein by reference.

### FIELD

The present disclosure relates to an anode active material, an anode for a secondary battery comprising the same, and a secondary battery comprising the same.

### BACKGROUND

With the rapid development of the electronic, communication, and computer industries, energy storage technology applications are expanding to camcorders, mobile phones, laptops, PCs, and even electric vehicles, among others. Lightweight, long-lasting, and highly reliable high-performance secondary batteries are desirable for such applications.

Among the secondary batteries currently in use, lithium-ion batteries developed in the early 1990s have higher operating voltage and energy density than conventional batteries such as Ni-MH, Ni—Cd, and lead-sulfur batteries that use aqueous electrolyte solutions. As such, lithium-ion batteries have been adopted as power sources for many portable devices.

Materials comprising graphite have been used as an anode active material of the lithium ion battery. Since the average potential when graphite absorbs/releases lithium is approximately 0.1 to 0.2 V (based on Li/Li+) and the discharge potential is relatively flat, there is an advantage in that a voltage of a battery using graphite is high and constant. However, there is a disadvantage in that graphite has a very small theoretical capacity of 372 mAh/g.

Therefore, various anode active materials are being studied to further increase the capacity of lithium ion batteries. As a high-capacity anode active material, materials that form intermetallic compounds with lithium, such as silicon or tin, are expected to be promising anode active materials. In particular, silicon is an alloy type anode active material with a theoretical capacity (4,200 mAh/g) that is about 10 times higher than that of graphite, and is attracting attention as a next-generation anode active material.

However, silicon-based anode active materials have a high material expansion rate, which is disadvantageous for the durability and stability of a cell.

The matters described in this Background section are only for enhancement of understanding of the background of the disclosure, and should not be taken as acknowledgement that they correspond to prior art already known to those skilled in the art.

### SUMMARY

The following summary presents a simplified summary of certain features. The summary is not an extensive overview and is not intended to identify key or critical elements.

In accordance with one aspect, an anode active material comprises: a first active material comprising a silicon-based material and a second active material comprising a carbon-based material. The second active material comprises at least one of the first carbon-based material and the second carbon-based material. A weight ratio of the first carbon-based material and the second carbon-based material satisfies the following Expression 1.

$$0 \leq x / y \leq 0.15 \qquad [ Expression 1 ]$$

wherein x denotes a weight of the first carbon-based material, and y denotes a weight of the second carbon-based material.

In accordance with another aspect, a pellet density of the second carbon-based material may be 1.7 g/cm³ or more.

In accordance with one aspect, the silicon-based material may comprise at least one selected from the group consisting of Si, SiOₓ (0<x<2), and SiC.

In in accordance with some aspects, the following Expression 2 may be satisfied.

$$0 < z / ( x + y + z ) < 0.15 \qquad [ Expression 2 ]$$

wherein x y are as previously defined and z denotes a weight of a silicon-based material.

In some aspects, a full length expansion rate or a full width expansion rate of the anode comprising the anode active material may satisfy the following Expression 3.

$$\begin{matrix}a 1 = k 1 * x / y \\ a 2 = k 2 * x / y\end{matrix} \qquad [ Expression 3 ]$$

wherein x and y are as previously defined, a1 denotes the full length expansion rate, a2 denotes the full width expansion rate, and k1 and k2 denote real numbers.

In accordance with one or more aspects, the first carbon-based material may be natural graphite.

In accordance with one or more aspects, the second carbon-based material may be artificial graphite.

In accordance with another aspect, an anode for a secondary battery may comprise the anode active material.

In accordance with still another aspect, a secondary battery may comprise the anode.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a diagram for describing an anode according to one or more examples of the present disclosure; and

FIG. 2 is a result of measuring a capacity retention rate of examples of the present disclosure and comparative examples.

FIG. 3 is a schematic diagram for a secondary battery according to an example of the present disclosure.

### DETAILED DESCRIPTION

Hereinafter, examples disclosed in the present specification will hereinafter be described in detail with reference to the accompanying drawings. In the following description, identical or similar components are given the same or similar reference numerals, and overlapping descriptions thereof may be omitted.

Unless otherwise defined, the terms used herein, including technical or scientific terms, may have meanings generally understood by those skilled in the art to which the present disclosure belongs.

In the present specification, the terms “include,” “comprise” or “have” indicate the presence of features, numbers, steps, operations, components, parts, or combinations thereof described in the specification, but do not exclude in advance any of the features, numbers, steps, operations, components, parts, or combinations thereof.

A singular expression used herein may include the meaning of the plural unless otherwise stated in the context, which also applies to the singular expression described in the claims.

For purposes of this application and the claims, using the exemplary phrase “at least one of: A; B; or C” or “at least one of A, B, or C,” the phrase means “at least one A, or at least one B, or at least one C. or any combination of at least one A, at least one B, and at least one C. Further, exemplary phrases, such as “A, B, or C”, “at least one of A, B, and C”. “at least one of A, B. or C”, etc. as used herein may mean each listed item or all possible combinations of the listed items. For example, “at least one of A or B” may refer to (1) at least one A; (2) at least one B: or (3) at least one A and at least one B.

The term “about” in relation to a reference numerical value, and its grammatical equivalents as used herein, can include the reference numerical value itself and a range of values plus or minus 10% from that reference numerical value. For example, the term “about 10” includes 10 and any amount from and including 9 to 11. In some cases, the term “about” in relation to a reference numerical value can also include a range of values plus or minus 10%, 9%, 8%, 7%, 6%, 5%, 4%, 3%, 2%, or 1% from that reference numerical value. In some embodiments, “about” in connection with a number or range measured by a particular method indicates that the given numerical value includes values determined by the variability of that method. Values and ranges disclosed herein may include the exact values and also, or alternatively, about the disclosed value.

Expressions such as “first” or “second” as used herein are used to distinguish one object from another in referring to multiple similar objects, unless otherwise indicated in context, and do not limit the order or importance between them. For example, a plurality of chips according to the present disclosure may be distinguished from each other by referring them as “first chip”, “second chip”, respectively.

The expression “based on” as used herein is intended to describe one or more factors that influence an act or operation of determining or deciding described in a phrase or sentence including that expression, and this expression does not exclude any additional factors that influence the act or operation of determining or deciding.

An anode active material according to one or more examples of the present disclosure may comprise a first active material and a second active material.

The first active material may comprise a silicon-based material.

The silicon-based material may be a silicon-based particle. In some examples, the silicon-based material may comprise at least one selected from the group consisting of Si, SiOₓ (0<x<2), and SiC.

The second active material may comprise a carbon-based material.

The second active material may comprise at least one first carbon-based material and at least one second carbon-based material.

In some examples, the first carbon-based material may be natural graphite. In some examples, the second carbon-based material may be artificial graphite. In some examples, the second carbon-based material may be a material having a pellet density of about 1.7 g/cm³ or more. For example, the second carbon-based material may be artificial graphite having a pellet density of about 1.7 g/cm³ or more. The pellet density is defined as the density measured after pouring the second carbon-based material into a circular mold with a diameter of 13 mm and applying a compression pressure of 4 tons. Since the pellet density of the second carbon-based material is about 1.7 g/cm³ or more, it may absorb a volume expansion of the first active material that may occur during charging and discharging. The second carbon-based material may perform a buffer action for the expansion of the first active material. In addition, it may delay or prevent the deterioration of an electrode comprising the anode active material.

The D10 of the second carbon-based material may be about 4.5 to about 8.5 μm. The D50 of the second carbon-based material may be about 11 to about 17 μm. The D90 of the second carbon-based material may be about 25 to about 30 μm. Since the particle size of the second carbon-based material has the above-described range, it may absorb the expansion of the silicon-based material.

The weight ratio of the first carbon-based material and the second carbon-based material in the second active material may satisfy the following Expression 1.

$$0 \leq x / y \leq 0.15 \qquad [ Expression 1 ]$$

wherein x denotes a weight of the first carbon-based material, and y denotes a weight of the second carbon-based material. In some examples, y may denote the weight of the second carbon-based material having a pellet density of about 1.7 g/cm³ or more.

By satisfying the above Expression 1, when the first active material comprising the silicon-based material expands, the second active material may perform a buffer action. In particular, when the anode active material is applied to the anode, the full length expansion or full width expansion of the anode may be prevented. In addition, by the anode active material satisfying Expression 1, the durability and stability of the secondary battery may be improved.

The anode active material according to one or more examples of the present disclosure may satisfy the following Expression 2.

$$0 < z / ( x + y + z ) < 0.15 \qquad [ Expression 2 ]$$

wherein x and y are as previously defined and z denotes a weight of a silicon-based material. In some examples, y may denote the weight of the second carbon-based material having a pellet density of about 1.7 g/cm³ or more. In some examples, x+y+z=100.

In some examples, the full length expansion rate or full width expansion rate of an anode comprising the anode active material may satisfy the following Expression 3.

$$\begin{matrix}a 1 = k 1 * x / y \\ a 2 = k 2 * x / y\end{matrix} \qquad [ Expression 3 ]$$

wherein x and y are as previously defined, a1 denotes the full length expansion rate of the anode, a2 denotes the full width expansion rate of the anode, and k1 and k2 denote real numbers. In some examples, y may denote the weight of the second carbon-based material having a pellet density of about 1.7 g/cm³ or more. According to some examples, 0<k1≤8 and 0<k2≤8.

The full length expansion rate may be calculated according to Equation 4 below, and the full width expansion rate may be calculated according to Equation 5 below.

$$a 1 = \frac{( Full length when State of Charge ( SOC ) is 100 - Full length when SOC is 0 )}{Full length when SOC is 0} * 100 \qquad [ Equation 4 ]$$

$$a 2 = \frac{( Full width when State of Charge ( SOC ) is 100 - Full width when SOC is 0 )}{Full width when SOC is 0} * 100 \qquad [ Equation 5 ]$$

When the anode active material satisfies Expression 2, the full length expansion rate or the full width expansion rate may be proportional to x/y. In addition, when the anode active material satisfies Expression, the value of the full length expansion rate or the full width expansion rate of the anode may be predicted using Expression 3.

In some examples, the first active material may be present in an amount exceeding about 8 wt % and less than about 15 wt % with respect to the total weight of the anode active material. For example, the first active material may be present in an amount of about 10 wt % to about 14 wt % with respect to the total weight of the anode active material. When the first active material is present in the above range, the battery capacity may be improved.

In some examples of an anode active material, the first carbon-based material may be present in an amount of 0 wt % to about 13.5 wt % with respect to the total weight of the anode active material. For example, the first carbon-based material may be present in an amount of 0 wt % to about 10 wt % with respect to the total weight of the anode active material.

In some examples of an anode active material, the second carbon-based material may be present in an amount exceeding about 85 wt % and less than about 92 wt % with respect to the total weight of the anode active material. For example, the second carbon-based material may be present in an amount of about 86 wt % to about 90 wt % with respect to the total weight of the anode active material.

According to the anode active material according to one or more examples of the present disclosure, it may be possible to prevent the expansion of the anode even if the anode active material comprises a silicon-based material having a high material expansion rate. That is, when the anode active material of the present disclosure is applied to the anode for a secondary battery, the full length expansion or full width expansion of the anode may be avoided. In addition, when the anode active material is applied to the secondary battery, it may be possible to improve the durability and stability of the secondary battery.

The anode for a secondary battery according to one or more examples of the present disclosure may comprise the anode active material described above. The anode active material may be present, for example, in an amount of about 95 wt % to about 98 wt % with respect to the entire anode for a secondary battery.

The anode according to one or more examples of the present disclosure may further comprise at least one of a conductive material, a binder, and a thickener.

A conductive material may be used to impart conductivity to the electrode, and any conductive material may be used as long as it does not cause a chemical change in the constituted battery and is an electrically conductive material. For example, the conductive material may comprise at least one selected from the group consisting of carbon black, acetylene black, Ketjen black, channel black, paneth black, lamp black, thermal black, conductive fiber, fluorocarbon, aluminum powder, nickel powder, zinc oxide, potassium titanate, titanium oxide, polyphenylene derivatives, carbon nanotube, plate-like graphite, graphene, graphene oxide, and graphite flake.

A binder may attach the anode active material particles to each other well and also attach the anode active material to a current collector well. The binder and/or thickener may comprise at least one selected from the group consisting of polyvinylidene fluoride-hexafluoropropylene copolymer (PVDF-co-HFP), polyvinylidene fluoride, polyacrylonitrile, polymethylmethacrylate, polyvinyl alcohol, carboxymethyl cellulose (CMC), starch, hydroxypropyl cellulose, regenerated cellulose, polyvinyl pyrrolidone, tetrafluoroethylene, polyethylene, polypropylene, polyacrylic acid, ethylene-propylene-diene monomer (EPDM), sulfonated EPDM, styrene butadiene rubber (SBR), fluoro rubber, and poly acrylic acid, and may also comprise various copolymers thereof.

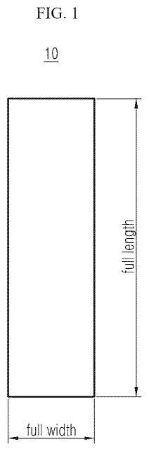

Referring to FIG. 1, the anode 10 for a secondary battery according to one or more examples of the present disclosure may prevent the full length expansion or full width expansion of the anode 10 even if it comprises a silicon-based material having a high material expansion rate. Therefore, it may be possible to improve the durability and stability of the secondary battery.

Referring to FIG. 3, the secondary battery according to one or more examples of the present disclosure may comprise the anode and the cathode described above.

The cathode may comprise a cathode active material, a conductive material, and a binder. The cathode active material may comprise at least one selected from the group consisting of, for example, nickel cobalt manganese (NCM), nickel cobalt aluminum (NCA), lithium manganese oxide (LMO), lithium cobalt oxide (LCO), and lithium iron phosphate (LFP). In some examples, the cathode active material may comprise NCM.

The secondary battery according to one or more examples of the present disclosure may comprise a separator and an electrolyte between the cathode and the anode.

The separator may separate the anode and the cathode and provide a passage through which lithium ions move. The separator may comprise a porous polymer film, for example, a porous polymer film made of a polyolefin-based polymer such as an ethylene homopolymer, a propylene homopolymer, an ethylene/butene copolymer, an ethylene/hexene copolymer, and an ethylene/methacrylate copolymer, or a laminated structure of two or more layers thereof. Alternatively, the separator may comprise a nonwoven fabric made of high-melting-point glass fibers, polyethylene terephthalate fibers, and the like.

The electrolyte may comprise an organic liquid electrolyte, an inorganic liquid electrolyte, a solid polymer electrolyte, a gel-type polymer electrolyte, a solid inorganic electrolyte, a molten inorganic electrolyte, and the like.

With a secondary battery according to one or more examples of the present disclosure, it may be possible to prevent the expansion of the anode even if the anode active material comprises a silicon-based material having a high material expansion rate. Therefore, it may be possible to prevent performance deterioration of the secondary battery. In addition, the secondary battery may have excellent durability and stability.

Example and Comparative Examples of the present disclosure will be described. The following Example is only an example of the present disclosure, and the present disclosure is not limited to the following Example.

### Example

Anode active materials having the compositions shown in Table 1 below were prepared.

Si powder was prepared as a first active material. Natural graphite was prepared as a first carbon-based material among second active materials. Artificial graphite having a D10 of 6.50 μm, a D50 of 14.7 μm, a D90 of 27.6 μm, and a pellet density of 1.75 g/cm³ was prepared as a second carbon-based material among the second active materials. Meanwhile, artificial graphite having a pellet density of 1.63 g/cm³ was also prepared as the second carbon-based material for comparison.

A binder was prepared by mixing styrene-butadiene rubber (SBR): carboxymethyl cellulose (CMC) in a 1:1 ratio. Carbon black was prepared as a conductive material, and CMC was prepared as a thickener.

The prepared anode active material:binder:conductive material:thickener were mixed in a weight ratio of 96:2:1:1, and then dispersed in water to prepare an anode slurry. This anode slurry was coated on a copper film, dried in an oven of 80° C. for about 2 hours, rolled at a pressure of 3.8 MPa, and further dried in a 110° C. vacuum oven for 12 hours to prepare an anode for a secondary battery.

As a cathode, a nickel-cobalt-manganese (NCM)-based cathode was prepared. As an electrolyte, a mixed solution of ethylene carbonate (EC), ethyl methyl carbonate (EMC), and ethyl propionate (EP), in which 0.5 M LiFSi and 0.5 M LiPF₆ are dissolved, was used.

A pouch cell was manufactured according to a commonly known manufacturing process.

The full length expansion rate and full width expansion rate of the anode were measured for the cell, and the results are shown in Table 1 below. Here, the full length expansion rate was calculated according to Equation 4 below, and the full width expansion rate was calculated according to Equation 5 below.

$$a 1 = \frac{( Full length when State of Charge ( SOC ) is 100 - Full length when SOC is 0 )}{Full length when SOC is 0} * 100 \qquad [ Equation 4 ]$$

$$a 2 = \frac{( Full width when State of Charge ( SOC ) is 100 - Full width when SOC is 0 )}{Full width when SOC is 0} * 100 \qquad [ Equation 5 ]$$

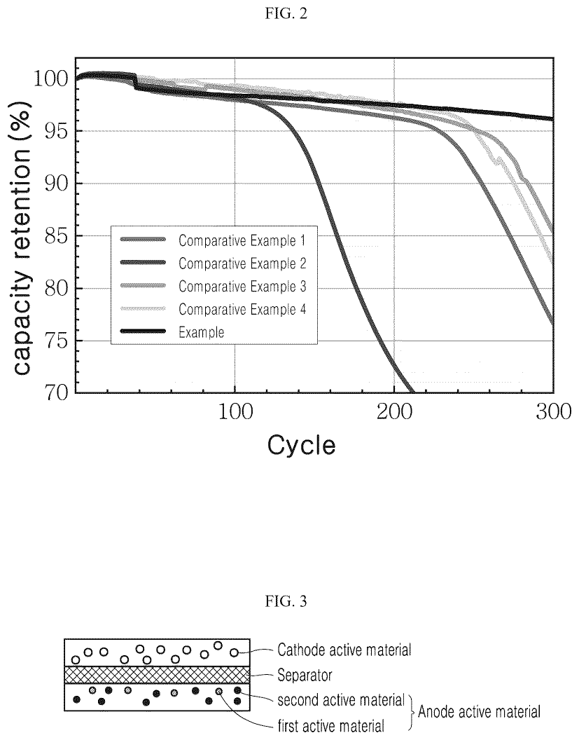

Meanwhile, a capacity retention rate was also measured, and the results are illustrated in FIG. 2.

TABLE 1

| | | | Com. | Com. | Com. | Com. | |
|---|---|---|---|---|---|---|---|
| | | | Ex. 1 | Ex. 2 | Ex. 3 | Ex. 4 | Ex. |
| First active material | | Si powder | 12 | 12 | 12 | 12 | 12 |
| Second active | First carbon-based | Natural graphite | 58 | 88 | 13 | — | — |
| material | material | | | | | | |
| | Second carbon- | Artificial graphite | — | — | — | 88 | — |
| | based material | (pellet density | | | | | |
| | | 1.63 g/cm³) | | | | | |
| | Second carbon- | Artificial graphite | 30 | — | 75 | — | 88 |
| | based material | (pellet density | | | | | |
| | | 1.75 g/cm³) | | | | | |

| | | | | | |
|---|---|---|---|---|---|
| x/y | 58/30 = 1.93 | — | 13/75 = 0.17 | 0 | 0 |
| (x denotes weight of first carbon-based material, and y | | | | | |
| denotes weight of second carbon-based material having | | | | | |
| pellet density of 1.7 g/cm³ or more.) | | | | | |
| z/(x + y + z) | 0.12 | 0.12 | 0.12 | 0.12 | 0.12 |
| (x denotes weight of first carbon-based material, y denotes | | | | | |
| weight of second carbon-based material having pellet | | | | | |
| density of 1.7 g/cm³ or more, and z denotes weight of | | | | | |
| silicon-based material) | | | | | |
| k1 | 0.777 | — | 7.647 | — | — |
| k2 | 0.88 | — | 7.059 | — | — |
| Full length expansion rate of anode (a1) (%) | 1.5 | 2.0 | 0.5 | 1 | 0 |
| Full width expansion rate of anode (a2) (%) | 1.7 | 2.1 | 0.7 | 1.1 | 0 |

Referring to Table 1 above, it was confirmed that the full length and full width expansion rate were 0 for the examples satisfying Expression 1 below.

$$0 \leq x / y \leq 0.15 \qquad [ Expression 1 ]$$

Meanwhile, in the case of Comparative Example 1 where x/y is 0.19 and Comparative Example 3 where x/y is 0.17, it was confirmed that both the full length and full width expansion rate showed values of 1% or more.

In addition, in the case of Comparative Example 2 which comprises only natural graphite as the second active material, it was determined that the full length and full width expansion rate were the highest, so that the durability performance was the worst.

In the case of Comparative Example 4 which comprises artificial graphite having a pellet density of 1.7 g/cm³ or less as the second carbon-based material, both the full length and full width expansion rate showed values of 1% or more.

In the case of Comparative Examples 1 and 3, and the Example satisfying Expression 2 below, it was confirmed that the full length expansion rate or the full width expansion rate of the anode satisfied Expression 3 below. That is, it was confirmed that the full length expansion rate or the full width expansion rate was proportional to x/y.

$$0 < z / ( x + y + z ) < 0 \text{.15} \qquad [ Expression 2 ]$$

$$\begin{matrix}a 1 = k 1 * x / y \\ a 2 = k 2 * x / y \\ ( 0 < k 1 \leq 8 , 0 < k 2 \leq 8 )\end{matrix} \qquad [ Expression 3 ]$$

Referring to FIG. 2, it was confirmed that the capacity of the Example did not decrease significantly even after 300 cycles compared to the Comparative Examples. That is, it was confirmed that the durability was maintained even though it comprised Si with a high volume expansion rate.

With the anode active material according to one or more examples of the present disclosure, it may be possible to prevent the expansion of the anode even if the anode active material comprises the silicon-based material having a high material expansion rate. That is, when the anode active material of the present disclosure is applied to the anode for a secondary battery, it may be possible to prevent the full length expansion or full width expansion of the anode. In addition, when the anode active material is applied to a secondary battery, it may be possible to improve the durability and stability of the secondary battery.

The effects of the present disclosure are not limited to those mentioned above, and other effects not mentioned can be clearly understood by those skilled in the art from the following description.

Hereinabove, examples of the present disclosure have been described with drawings. This is illustrative, and the present disclosure is not limited to the contents of the above-described examples and drawings.

It would be obvious to those skilled in the art that the present disclosure can be modified within the scope of the disclosed technical idea. The described examples should be viewed as part of the present disclosure, and the scope of the present disclosure should not be limited only through the described examples.

The scope of the present disclosure should be judged by the technical idea described in the claims. In addition, even if the actions or effects according to the configuration are not explicitly described while describing the examples of the present disclosure, it is obvious that the actions or effects that are predictable by the configuration should be recognized as the present disclosure.

1. An anode active material, comprising:
a first active material comprising a silicon-based material; and
a second active material comprising a carbon-based material,
wherein the second active material comprises at least one of the first carbon-based material and the second carbon-based material,
wherein a full length expansion rate or a full width expansion rate of an anode comprising the anode active material satisfies the following Expression 3:
$$\begin{matrix}a 1 = k 1 * x / y \\ a 2 = k 2 * x / y ,\end{matrix} \qquad [ Expression 3 ]$$
wherein a1 denotes the full length expansion rate, a2 denotes the full width expansion rate, k1 and k2 denote real numbers, and x denotes a weight of the first carbon-based material, and y denotes a weight of the second carbon-based material.

2. The anode active material of claim 1, wherein a pellet density of the second carbon-based material is about 1.7 g/cm³ or more.

3. The anode active material of claim 1, wherein the silicon-based material comprises at least one selected from the group consisting of Si, SiOₓ (0<x<2), and SiC.

4. The anode active material of claim 1, wherein the following Expression 2 is satisfied:
$$0 < z / ( x + y + z ) < 0 \text{.15} , \qquad [ Expression 2 ]$$
wherein z denotes a weight of the silicon-based material.

5. The anode active material of claim 1, wherein the first carbon-based material is natural graphite.

6. The anode active material of claim 1, wherein the second carbon-based material is artificial graphite.

7. An anode for a secondary battery comprising the anode active material of claim 1.

8. A secondary battery comprising the anode of claim 7.

9. An anode active material, comprising:
a first active material comprising a silicon-based material selected from the group consisting of Si, SiOₓ (0<x<2), and SiC; and
a second active material comprising a first carbon-based material which is natural graphite and a second carbon-based material which is artificial graphite,
wherein a weight ratio of the silicon-based material, the first carbon-based material and the second carbon-based material satisfies the following Expression 2:
$$0 < z / ( x + y + z ) < 0 \text{.15} , \qquad [ Expression 2 ]$$
wherein x denotes a weight of the first carbon-based material, y denotes a weight of the second carbon-based material and z denotes a weight of the silicon-based material.

10. The anode active material of claim 9, wherein a pellet density of the second carbon-based material is about 1.7 g/cm³ or more.

11. An anode for a secondary battery comprising the anode active material of claim 9.

12. A secondary battery comprising the anode of claim 11.
